(19) United States
(12) Patent Application Publication
(10) Pub. No.: US 2012/0166621 A1
(43) Pub. Date: Jun. 28, 2012

(54) Sharing the Status of S-CSCF Nodes Across I-CSCF Nodes in a Communications Network

(76) Inventors: Anish Sharma, Bangalore (IN); Ashish Nagpal, Bangalore (IN); Justin Scott Hart, Purton (GB)

(21) Appl. No.: 12/977,990

(22) Filed: Dec. 23, 2010

(51) Int. Cl. G06F 15/173

(52) U.S. Cl. 709/224

(57) ABSTRACT

Methods and apparatuses, including computer program products, are described for sharing the status of S-CSCF nodes across a plurality of I-CSCF nodes in a communications network. The system includes a first I-CSCF node of the plurality of I-CSCF nodes configured to monitor status of one or more S-CSCF nodes connected to the first I-CSCF node, wherein the one or more S-CSCF nodes connected to the first I-CSCF node comprise a subset of the S-CSCF nodes in the network, and transmit the monitored status of the one or more S-CSCF nodes connected to the first I-CSCF node to a second I-CSCF node. The second I-SCSF node is configured to monitor status of one or more S-CSCF nodes connected to the second I-CSCF node, wherein the one or more S-CSCF nodes connected to the second I-CSCF node comprise a subset of the S-CSCF nodes in the network.

### FIELD OF THE INVENTION

The subject matter of this application relates generally to methods and apparatuses, including computer program products, for sharing the status of S-CSCF nodes across a plurality of I-CSCF nodes in a communications network.

### BACKGROUND OF THE INVENTION

As communications networks become larger in scale, it becomes desirable to distribute processing across the network, as any point of centralization generally becomes a bottleneck. Load balancing and status monitoring across nodes in such networks becomes a greater challenge. For example, in Internet Protocol Multimedia Subsystem (IMS) networks, control elements such as interrogating call session control function (I-CSCF) nodes are generally centralized. In order to scale this logical function, it is desirable to distribute the processing to multiple points in the network, however doing so has the effect of making load management in the network a more complex function. In addition, as the intelligence to make decisions about allocating, routing and admitting sessions to nodes is distributed to more and more elements, the ability for any one node to make optimal decisions is diminished.

This diminished decision-making ability results from having distributed logic across many nodes because any particular node generally has a narrower view of the overall load and health of the network. In many of the currently-existing network types and configurations, nodes are reduced to making resource decisions based on their individual experience of the sessions that they encounter. The nodes have little or no information about the load or health of the other nodes in the network. In other currently-existing network types, nodes are able to communicate load and availability information with their immediate peers, thereby enhancing the set of data available to a particular node for decision making.

In contrast, some networks have a highly centralized control element for allocation, routing, and administration decisions. Generally, these networks can control load distribution and resource allocation more efficiently than a network with highly distributed control logic because the resource decisions are made at a single node that has a very expansive view of the network status. However, such centralized networks have issues related to congestion of the decision making process as all of the session traffic has to be processed by the centralized control element. This centralized control approach limits scaling and can give rise to overloading difficulties.

Therefore, what is required is a technique to distribute control logic to multiple I-CSCF in IMS networks, but also to have the I-CSCFs sufficiently aware of the network status of other nodes, such as serving call session control function (S-CSCF) nodes, such that the I-CSCF nodes still make optimal resource decisions. What is further required is a technique for each I-CSCF in the network to communicate partial views of network status to other I-CSCFs in an efficient and scalable fashion such that any one I-CSCF can eventually obtain a complete view of the network status of all S-CSCFs in the network without encountering the scalability and load issues associated with conducting a mass broadcast of the status information to every other I-CSCF.

### SUMMARY OF THE INVENTION

The invention, in one aspect, features a method for sharing the status of S-CSCF nodes across a plurality of I-CSCF nodes in a communications network. The method includes monitoring, at a first I-CSCF node of the plurality of I-CSCF nodes, the status of one or more S-CSCF nodes connected to the first I-CSCF node. The one or more S-CSCF nodes connected to the first I-CSCF node include a subset of the S-CSCF nodes in the network. The method also includes monitoring, at a second I-CSCF node of the plurality of I-CSCF nodes, the status of one or more S-CSCF nodes connected to the second I-CSCF node. The one or more S-CSCF nodes connected to the second I-CSCF node include a subset of the S-CSCF nodes in the network. The method also includes transmitting, from the first I-CSCF node to the second I-CSCF node, the monitored status of the one or more S-CSCF nodes connected to the first I-CSCF node.

The invention, in another aspect, features a system for sharing the status of S-CSCF nodes across a plurality of I-CSCF nodes in a communications network. The system includes a first I-CSCF node of the plurality of I-CSCF nodes configured to monitor status of one or more S-CSCF nodes connected to the first I-CSCF node. The one or more S-CSCF nodes connected to the first I-CSCF node include a subset of the S-CSCF nodes in the network. The first I-CSCF node is further configured to transmit the monitored status of the one or more S-CSCF nodes connected to the first I-CSCF node to a second I-CSCF node of the plurality of I-CSCF nodes. The second I-SCSF node is configured to monitor status of one or more S-CSCF nodes connected to the second I-CSCF node. The one or more S-CSCF nodes connected to the second I-CSCF node include a subset of the S-CSCF nodes in the network.

The invention, in another aspect, features a computer program product, tangibly embodied on a computer readable storage medium, for sharing the status of S-CSCF nodes across a plurality of I-CSCF nodes in a communications network. The computer program product includes instructions operable to cause a data processing apparatus to monitor, at a first I-CSCF node of the plurality of I-CSCF nodes, the status of one or more S-CSCF nodes connected to the first I-CSCF node. The one or more S-CSCF nodes connected to the first I-CSCF node include a subset of the S-CSCF nodes in the network. The computer program product also includes instructions operable to cause the data processing apparatus to monitor, at a second I-CSCF node of the plurality of I-CSCF nodes, the status of one or more S-CSCF nodes connected to the second I-CSCF node. The one or more S-CSCF nodes connected to the second I-CSCF node include a subset of the S-CSCF nodes in the network. The computer program product also includes instructions operable to cause the data processing apparatus to transmit, from the first I-CSCF node to the second I-CSCF node, the monitored status of the one or more S-CSCF nodes connected to the first I-CSCF node

In some embodiments, any of the above aspects can include one or more of the following features. In some embodiments, at least one S-CSCF node in the first subset of the S-CSCF nodes is also in the second subset of S-CSCF nodes in the network. In some embodiments, the monitored status of the one or more S-CSCF nodes connected to the first I-CSCF node is transmitted from the first I-CSCF node to a third I-CSCF node of the plurality of I-CSCF nodes. In some embodiments, the monitored status of the one or more S-CSCF nodes connected to the first I-CSCF node is transmitted from the second I-CSCF node to a third I-CSCF node of the plurality of I-CSCF nodes. In some embodiments, at least one of the one or more S-CSCF nodes connected to the second I-CSCF node is also monitored by the first I-CSCF node. In some embodiments, the monitored status of each of the one or more S-CSCF nodes connected to the first I-CSCF node includes an identification attribute associated with a time, a duration or both of an event occurring at the one or more S-CSCF nodes. In some embodiments, the identification attribute comprises at least one of a timestamp, a hash value, and an identification number.

In some embodiments, monitoring the status of one or more S-CSCF nodes connected to the first I-CSCF node includes active probing of the one or more S-CSCF nodes by the first I-CSCF node. In some embodiments, monitoring the status of one or more S-CSCF nodes connected to the first I-CSCF node includes passive analysis of traffic received from the one or more S-CSCF nodes by the first I-CSCF node.

In some embodiments, the monitored status of the one or more S-CSCF nodes connected to the second I-CSCF node is received at the first I-CSCF node from the second I-CSCF node, and the monitored status of the one or more S-CSCF nodes connected to the second I-CSCF node is stored at the first I-CSCF node. In some embodiments, the first I-CSCF node stores the monitored status of the one or more S-CSCF nodes connected to the second I-CSCF node in a data structure located at the first I-CSCF node.

In some embodiments, the monitored status of one or more S-CSCF nodes connected to the third I-CSCF node is received at the first I-CSCF node from a third I-CSCF node of the plurality of I-CSCF nodes, and the monitored status of the one or more S-CSCF nodes connected to the third I-CSCF node is stored at the first I-CSCF node. In some embodiments, a service request from a remote device is received at the first I-CSCF node, and the service request is routed by the first I-CSCF node one of the S-CSCF nodes in the network, wherein the routing is based on the monitored status of the S-CSCF nodes. In some embodiments, the monitored status of the one or more S-CSCF nodes connected to the third I-CSCF node is transmitted from the first I-CSCF node to the second I-CSCF node.

In some embodiments, an update to the monitored status of the one or more S-CSCF nodes connected to the second I-CSCF node is received at the first I-CSCF node from the second I-CSCF node, and the update to the monitored status of the one or more S-CSCF nodes connected to the second I-CSCF node is stored at the first I-CSCF node. In some embodiments, an update to the monitored status of the one or more S-CSCF nodes connected to the second I-CSCF node is received at the first I-CSCF node from the third I-CSCF node, an identification attribute of the update received from the third I-CSCF node is compared at the first I-CSCF node with an identification attribute of the update received from the second I-CSCF node, and the update received from the third I-CSCF node is discarded at the first I-CSCF node if the identification attribute of the update received from the third I-CSCF node and the identification attribute of the update received from the second I-CSCF node match. In some embodiments, the second I-CSCF node transmits the update based on a change in the monitored status of the one or more S-CSCF nodes connected to the second I-CSCF node.

In some embodiments, the connection between the first I-CSCF node and the second I-CSCF node is monitored at the first I-CSCF node. In some embodiments, the connection between the first I-CSCF node and the second I-CSCF node is unidirectional from the first I-CSCF node and the second I-CSCF node. In some embodiments, the directionality of the connection between the first I-CSCF node and the second I-CSCF node is preconfigured at the first I-CSCF node, the second I-CSCF node, or both.

In some embodiments, a failure of the connection between the first I-CSCF node and the second I-CSCF node is detected at the first I-CSCF node, and an indication of the failure of the connection between the first I-CSCF node and the second I-CSCF node is transmitted from the first I-CSCF node to a third I-CSCF node, wherein the connection between the first I-CSCF node and the third I-CSCF node is unidirectional from the first I-CSCF node to the third I-CSCF node. In some embodiments, the connection between the first I-CSCF node and the third I-CSCF node is updated at the third I-CSCF node to be bidirectional, and the monitored status of one or more S-CSCF nodes connected to the third I-CSCF node is transmitted from the third I-CSCF node to the first I-CSCF node.

In some embodiments, the connection between the first I-CSCF node and the second I-CSCF node is defined by an IP address of the second I-CSCF node stored at the first I-CSCF node. In some embodiments, the connection between the first I-CSCF node and the second I-CSCF node is defined by an IP address of the first I-CSCF node discovered by the second I-CSCF node upon receiving a connection request from the first I-CSCF node. In some embodiments, the discovery of the IP address of the first I-CSCF node by the second I-CSCF node is based on a packet received from the first I-CSCF node. In some embodiments, the IP address of the first I-CSCF node is stored in a source address field of the packet received from the first I-CSCF node. In some embodiments, the packet received from the first I-CSCF node is the first packet in a handshake routine associated with the connection request.

In some embodiments, the connection between the first I-CSCF node and each one of the one or more S-CSCF nodes connected to the first I-CSCF node is defined by an IP address of each one of the one or more S-CSCF nodes stored at the first I-CSCF node. In some embodiments, the connection between the first I-CSCF node and each one of the one or more S-CSCF nodes connected to the first I-CSCF node is defined by an IP address of each one of the one or more S-CSCF nodes discovered by the first I-CSCF node upon starting up the first I-CSCF node.

In some embodiments, the plurality of I-CSCF nodes in the communications network are arranged in a flat chain structure, a ring structure, a hierarchical structure, a full mesh structure, or one or more partial mesh structures. In some embodiments, the monitored status of the one or more S-CSCF nodes connected to the first I-CSCF node includes at least one of workload data, availability data, traffic congestion data, and control data.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of an exemplary system for sharing the status of S-CSCF nodes across a plurality of I-CSCF nodes in a communications network.

FIG. 2 is a block diagram exemplary system for sharing the status of S-CSCF nodes across a plurality of I-CSCF nodes in a communications network, where each I-CSCF node is connected to a subset of S-CSCF nodes.

FIG. 3 is a block diagram of an exemplary system for sharing the status of S-CSCF nodes across a plurality of I-CSCF nodes in a communications network, where each I-CSCF node is connected to a subset of S-CSCF nodes and each I-CSCF node is connected to another I-CSCF node.

FIG. 4 is a flow diagram of an exemplary method for sharing the status of S-CSCF nodes across a plurality of I-CSCF nodes in a communications network.

FIG. 5 is a block diagram of an exemplary I-CSCF node configuration for sharing the status of S-CSCF nodes across a plurality of I-CSCF nodes in a communications network, where the connections between the I-CSCF nodes are unidirectional.

FIG. 6 is a block diagram of an exemplary I-CS CF node configuration for sharing the status of S-CSCF nodes across a plurality of I-CSCF nodes in a communications network, where the connections between the I-CSCF nodes are bidirectional.

FIGS. 7A-B are block diagrams of an exemplary I-CSCF node configuration for sharing the status of S-CSCF nodes across a plurality of I-CSCF nodes in a communications network, where the connections between the I-CSCF nodes are adaptive.

### DETAILED DESCRIPTION

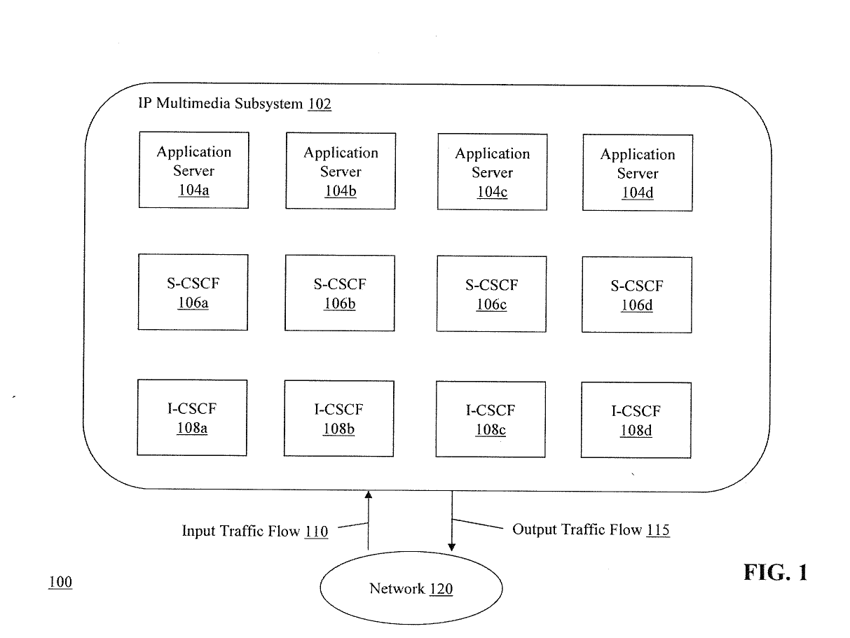

FIG. 1 is a block diagram of an exemplary system 100 for sharing the status of S-CSCF nodes across a plurality of I-CSCF nodes in a communications network. The system 100 includes an IMS 102, which includes a plurality of application servers 104a-d, a plurality of S-CSCF nodes 106a-d, and a plurality of I-CSCF nodes 108a-d. The system also includes an input traffic flow 105 and an output traffic flow 110 which connect the IMS 102 to a network (e.g., communications network 120). One of ordinary skill in the art will understand that the techniques described herein can be implemented on many different server types, network configurations, and/or computing devices without departing from the spirit or scope of the invention.

In some embodiments, the IMS 102 includes any number of application servers 104a-d, S-CSCF nodes 106a-d, and I-CSCF nodes 108a-d. While FIG. 1 includes four nodes of each type, it should be understood that the techniques described herein are not limited to four nodes of each type and the IMS 102 can include more or fewer nodes of each type without affecting the scope of the invention.

In some embodiments, the application servers 104a-d host and execute services in response to requests for service from a remote user. For example, the application servers 104a-d can provide VoIP calling services to a subscriber base. The application servers 104a-d can communicate with the S-CSCF nodes 106a-d using, for example, Session Initiation Protocol (SIP). For example, a “subscriber” can be an individual user, a group of users, a business, a corporation, or an entity that can access the service provider's network. One of ordinary skill in the art will understand that the techniques described herein are not limited to application on network traffic initiated or provided by a particular configuration of subscribers or users.

The S-CSCF nodes 106a-d comprise the signaling layer of the IMS 102. In some embodiments, the S-CSCF nodes 106a-d perform a variety of functions, such as session control. For example, the S-CSCF nodes 106a-d can interface to a Home Subscriber Server (HSS) (not shown) to retrieve subscription-related information (e.g., subscriber profiles), authentication and authorization information, and the subscriber's location and IP information. In some embodiments, the S-CSCF nodes 106a-d provide additional functionality including but not limited to SIP registrations, message inspection, routing services (e.g., ENUM lookups), and network policy enforcement.

The I-CSCF nodes 108a-d comprise the control layer of the IMS 102. In some embodiments, the I-CSCF nodes 108a-d communicate with remote servers over a network (e.g., network 120) and receive requests from subscribers to the network 120. For example, the I-CSCF nodes 108a-d can receive a request for SIP registration from a remote subscriber. Based on the request, the I-CSCF nodes 108a-d can query the HSS for registration status of the subscriber. The HSS returns, to the I-CSCF nodes 108a-d, either of (a) an S-CSCF node if the subscriber is already registered, (b) a list of S-CSCF nodes that are considered as candidate S-CSCF nodes, or (c) subscriber capabilities. In the case of (b), the I-CSCF nodes 108a-d select an S-CSCF node from the list, retrieve an address of the selected S-CSCF node, and assign the address to the registration request in order to forward the request to the assigned S-CSCF node 106a-d. In the case of (c), the I-CSCF nodes 108a-d match the capabilities returned by the HSS with the capabilities of the S-CSCF nodes, and select the optimal S-CSCF node based on the capability match. Because the I-CSCF nodes 108a-d are aware of the load and availability characteristics of each S-CSCF node in the network 120, these techniques provide the advantage of enabling the I-CSCF nodes 108a-d to select an S-CSCF node with, for example, the lightest workload from the list of S-CSCF nodes that match the required capabilities.

In addition, the I-CSCF nodes 108a-d monitor the load and availability status of the S-CSCF nodes 106a-d. The I-CSCF nodes 108a-d receive continuous feedback from the S-CSCF nodes 106a-d as to their actual load and availability status. Examples of such monitoring include the use of an IP “ping” to test if the S-CSCF nodes 106a-d respond, inferring the load and availability status of the S-CSCF nodes 106a-d based on the variation in response times, and the Address Reachability Service (ARS) from Sonus Networks, Inc. of Westford, Mass., which is suited to SIP based applications such as an IMS network.

In some embodiments, the application servers 104a-d, S-CSCF nodes 106a-d, and I-CSCF nodes 108a-d are hardware or software modules (e.g., implemented on a processor or other computing device) that are located on a single physical machine (e.g., a server). In some embodiments, the application servers 104a-d, S-CSCF nodes 106a-d, and I-CSCF nodes 108a-d comprise separate physical machines connected via a communications network (e.g., LAN, Internet).

In some embodiments, the input traffic flow 110 and the output traffic flow 115 include a series of packets, which are units of data formatted for transmission over a communications network. A packet generally includes metadata and a payload. The packet metadata includes attributes related to the packet (e.g., arrival information, destination information, origin information, encoding protocols, or structure of information in the packet). The payload includes the user data to be transmitted. In some embodiments, the input traffic flow 110 and the output traffic flow 115 comprise a single physical and/or logical connection between the IMS 102 and the communications network 120.

One or more of the packets in the traffic flows 115, 120 can include an event. In some embodiments, the event is associated with the signaling protocol of the traffic flows 115, 120. For example, the event can be an SIP REGISTER request or an SIP INVITE request. Events in the traffic flows 115, 120 can be related to each other, for example, on the basis of their sequence in the traffic flows 115, 120. In some embodiments, the event is associated with the media content (e.g., media type, encoding protocol, etc.) of the traffic flows 115, 120. For example, the event can be based on a particular codec used by the subscriber's equipment or network.

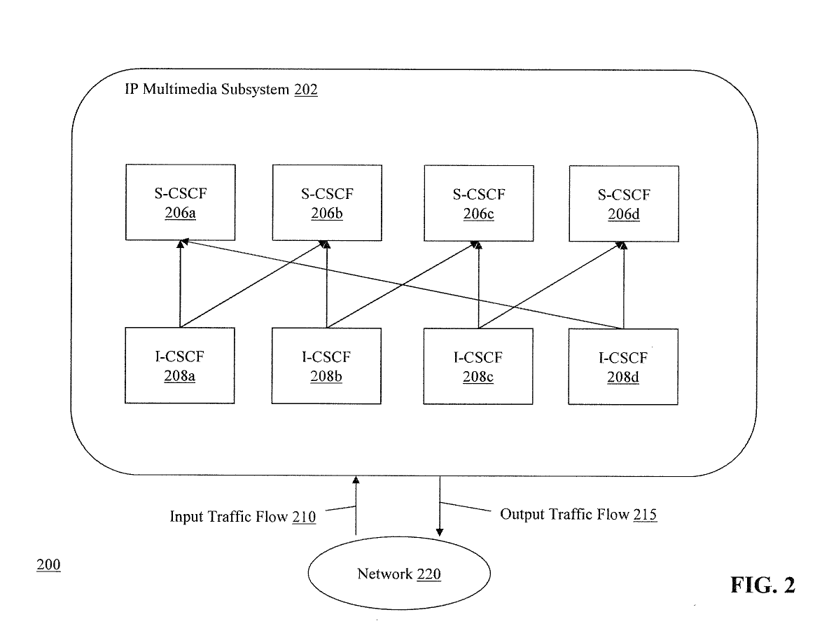

FIG. 2 is a block diagram exemplary system 200 for sharing the status of S-CSCF nodes across a plurality of I-CSCF nodes in a communications network, where each I-CSCF node is connected to a subset of S-CSCF nodes. The system 100 includes an IMS 202, which includes a plurality of S-CSCF nodes 206a-d and a plurality of I-CSCF nodes 208a-d. The system also includes an input traffic flow 210 and an output traffic flow 215 which connect the IMS 202 to a network (e.g., communications network 220). One of ordinary skill in the art will understand that the techniques described herein can be implemented on many different server types, network configurations, and/or computing devices without departing from the spirit or scope of the invention.

As shown in FIG. 2, a first I-CSCF node (e.g., node 208a) is connected to a subset of S-CSCF nodes (e.g., nodes 206a, 206b) and a second I-CSCF node (e.g., node 208b) is connected to a different subset of S-CSCF nodes (e.g., nodes 206b, 206c). In this embodiment, the subsets overlap so that each S-CSCF node 206a-d is monitored by at least two I-CSCF nodes 208a-d. For example, the S-CSCF node 206b is monitored by the I-CSCF node 208a and the I-CSCF node 208b. The overlap in monitoring provides redundancy, such that even in the event that a particular I-CSCF node fails, all of the S-CSCF nodes in the network remain monitored. Still referring to FIG. 2, the I-CSCF node 208a monitors S-CSCF nodes 206a and 206b. If the I-CSCF node 208a fails, S-CSCF node 206a is still monitored by I-CSCF node 208d and S-CSCF node 206b is still monitored by I-CSCF node 208b.

As shown in FIG. 2, each I-CSCF node 208a-d monitors two S-CSCF nodes 206a-d for a 1:2 monitoring ratio. However, it should be understood that the cardinality in FIG. 2 is only an example and the underlying technique described herein extends to any arbitrary cardinality. Generally, a determination of how much redundancy to build into the IMS 202 is based on a trade-off between the number of connections, where more connections increases the load on the network, and the amount of resilience to connection failure that the network builder prefers. Also, FIG. 2 shows that a single I-CSCF node (e.g., node 208a) only knows the status of two S-CSCF nodes (e.g., nodes 206a and 206b). However, the I-SCSF node 208a is able to direct incoming service requests to any of the S-CSCF nodes 206a-d in an optimal manner, because although the I-CSCF node 208a is only able to understand directly the load and availability status of the S-CSCF nodes 206a-d which the I-CSCF node 208a is monitoring, the techniques described herein provide that I-CSCF node 208a is aware of the load and availability status of each of the S-CSCF nodes 206a-d in the network.

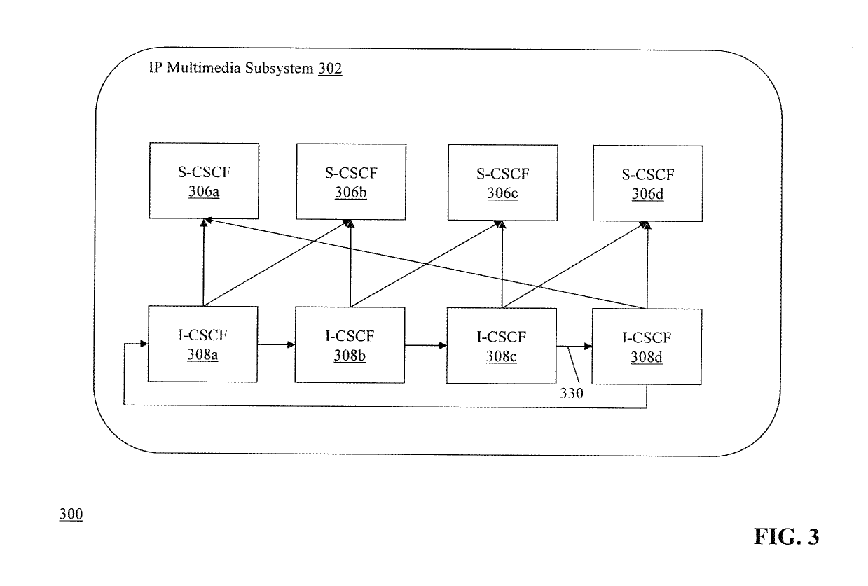

FIG. 3 is a block diagram of an exemplary system 300 for sharing the status of S-CSCF nodes across a plurality of I-CSCF nodes in a communications network, where each I-CSCF node is connected to a subset of S-CSCF nodes and each I-CSCF node is connected to another I-CSCF node.

As shown in FIG. 3, each of the I-CSCF nodes monitors a subset of the S-CSCF nodes 306a-d in a similar fashion to FIG. 2. FIG. 3 also shows that each I-CSCF node is connected to another I-CSCF node. For example, I-CSCF node 308c is connected to I-CSCF node 308d via connection 330. The connections between the respective I-CSCF nodes 308a-d provide the capability for each I-CSCF node to share the monitored status of the S-CSCF nodes that the I-CSCF node directly monitors with the other I-CSCF nodes in the network. For example, I-CSCF node 308a monitors S-CSCF nodes 306a and 306b and communicates with I-CSCF node 308b. Therefore, I-CSCF node 308a is able to share the monitoring status of S-CSCF nodes 306a and 306b with I-CSCF node 308b to provide node 308b with an understanding of the load and availability status of S-CSCF node 306a even though I-CSCF node 308b does not directly monitor S-CSCF node 306a. An advantage of this technique is that once the I-CSCF nodes 308a-d have completed the process of sharing the monitored status of the S-CSCF nodes 306a-d with each other, each I-CSCF node 308a-d has a complete understanding of the load and availability status of all of the S-CSCF nodes 306a-d in the IMS 302.

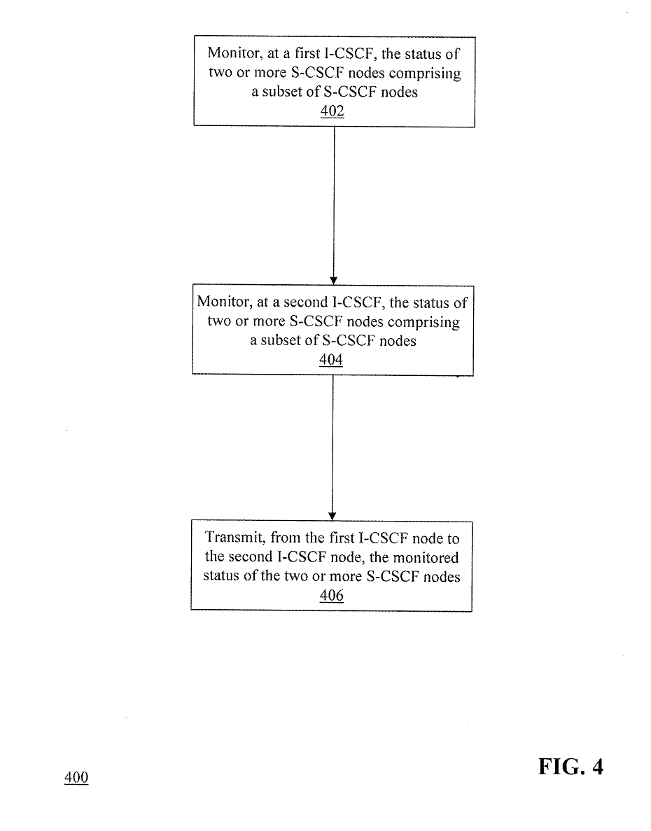

FIG. 4 is a flow diagram of an exemplary process 400 for sharing the status of S-CSCF nodes across a plurality of I-CSCF nodes in a communications network using the system 300 of FIG. 3. A first I-CSCF node 308a monitors (402) the load and availability status of two S-CSCF nodes 306a and 306b that are connected to the first I-CSCF node 308a. The two monitored S-CSCF nodes 306a and 306b are a subset of the entire group of S-CSCF nodes 306a-d. A second I-CSCF node 308b monitors (404) the load and availability status of two S-CSCF nodes 306b and 306c that are connected to the second I-CSCF node 308b. The two S-CSCF nodes 306b and 306c are a subset of the entire group of S-CSCF nodes 306a-d, and one of the S-CSCF nodes 306b is monitored by both the first I-CSCF node 308a and the second I-CSCF node 308b. The first I-CSCF node 308a transmits (406) to the second I-CSCF node 308b the monitored status of the two S-CSCF nodes 306a and 306b connected to the first I-CSCF node 308a.

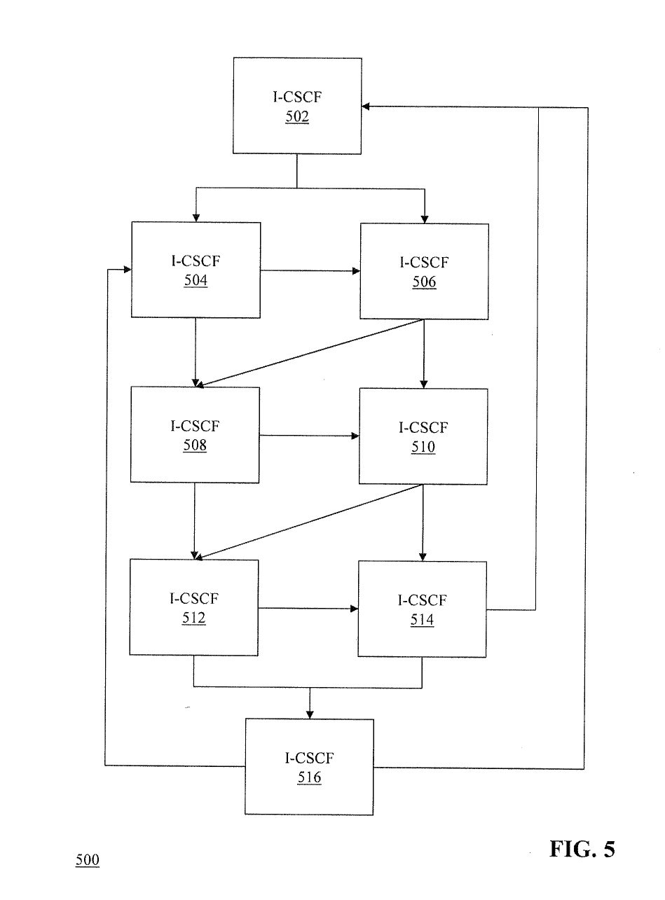

FIG. 5 is a block diagram of an exemplary I-CSCF node configuration 500 for sharing the status of S-CSCF nodes across a plurality of I-CSCF nodes (e.g., nodes 502-516) in a communications network, where the connections between the I-CSCF nodes 502-516 are unidirectional.

As shown in FIG. 5, each I-CSCF node is connected to two other I-CSCF nodes for the purpose of transmitting S-CSCF status information. For example, I-CSCF node 502 is connected to nodes 504 and 506 via unidirectional connections, such that node 502 transmits S-SCSF status information to nodes 504 and 506. An advantage provided by the use of unidirectional communications is the minimization of the quantity of messages that are generated and transmitted in the network, leading to increased efficiency and a reduction of workload borne by the nodes of the system.

I-CSCF node 502 is also connected to node 516, but node 502 can only receive status information from node 516. The configuration 500 of I-CSCF nodes 502-516 shown in FIG. 5 provides the advantage of having multiple connections between I-CSCF nodes to reduce the impact of I-CSCF node failures. Each of the I-CSCF nodes 502-516 shares the S-CSCF status information learned

from their monitoring activities with two downstream peer I-CSCF nodes. For example, I-CSCF node 504 is connected to nodes 506 and 508 via a unidirectional connection from 504 to 506 and 508, respectfully. Therefore, nodes 506 and 508 are considered to be downstream from node 504. It should be understood that the downstream ratio of 1:2 as shown in FIG. 5 is only an example and the underlying technique described herein extends to any arbitrary cardinality.

Continuing with FIG. 5, each of the downstream I-CSCF nodes (e.g., nodes 506 and 508) distributes the S-CSCF status information received from node 504 to their respective downstream peers. For example, node 506 transmits the S-CSCF status information learned from node 504, along with the S-CSCF status information that node 506 has gained from monitoring, to nodes 508 and 510. As a result of this downstream sharing technique, all of the I-CSCF nodes 502-516 learn the status information of every S-CSCF node available to the I-CSCF nodes 502-516.

In some embodiments, further enhancements are made to the downstream sharing technique to improve its efficiency and fault tolerance.

Sharing of Configuration and Status Information at Start-up Time

In some embodiments, when the IMS (e.g., IMS 102 in FIG. 1, IMS 202 in FIG. 2, or IMS 302 in FIG. 3) is initially brought online, the I-CSCF nodes within the IMS can share the configuration (e.g., connection architecture) and status information of all nodes in the IMS, including S-CSCF nodes. An advantage of this initial structure sharing is that each I-CSCF can build an initial view of the entire network and thereafter the I-CSCF nodes only need to transmit status information to other I-CSCF nodes when an update is required (e.g., when a notable change in availability or load status of an S-CSCF occurs). This technique reduces the amount of status information that is transmitted by the I-CSCF nodes, thereby using less I-CSCF processing and communication bandwidth.

Loop Prevention

Another enhancement present in some embodiments is loop prevention. For example, I-CSCF nodes 502-516 can include a loop prevention processing function. Generally, loop prevention solves the complexity of transmission of duplicate status information messages between I-CSCF nodes 502-516. Continuing with the example presented above, node 504 transmits S-CSCF status information learned from its monitoring activities to nodes 506 and 508. Node 506 transmits S-CSCF status information learned from node 504 and monitored by node 506 to node 508. According to this sequence of events, node 508 receives S-CSCF status information monitored by node 504 twice—once from node 504 and once from node 506. Unless node 508 recognizes the duplicate status information, that information can be propagated by node 508 twice to its downstream peer I-CSCF nodes (e.g., nodes 510 and 512). Therefore, it is desirable to stop propagation of duplicate status information messages for an increase in efficiency and reduction of traffic load.

In some embodiments, each I-CSCF node (e.g., nodes 108a-d, nodes 208a-d, nodes 308a-d, node 502) maintains a table or other similar data structure of the current status for each of the S-CSCF nodes for which the I-CSCF node has received status information. For example, the table can identify the individual S-CSCF nodes by an identification number. The status maintained in the table can also include a timestamp of the last received status update message for the individual S-CSCF nodes. To accomplish this, each I-CSCF node (e.g., node 502) can, for example, include a timestamp with each status information update message that the node 502 originates via its direct monitoring activities before transmitting the update message to the node's 502 downstream I-CSCF peers (e.g., nodes 504 and 506). A downstream I-CSCF node 504 compares the timestamp of the status update message for a particular S-CSCF node received from the peer I-CSCF node 502 with the timestamp stored in the table for the same S-CSCF node. If the downstream I-CSCF node 504 determines that the timestamps match, the node 504 determines that a duplicate message has been received and drops the message, preventing further propagation.

Longest Path and Isolation

In some embodiments, the techniques described herein are further enhanced to resolve complexities associated with (i) the longest path that a particular status information message must travel among the I-CSCF nodes, and (ii) isolation of an I-CSCF node due to an unforeseen failure (e.g., hardware failure, network connection failure).

A) Longest Path

When the S-CSCF status information must pass through multiple I-CSCFs in order to reach all destinations, it is important to consider the longest path the message must take before each I-CSCF node receives the status information because with each additional hops the message must travel, the time required to transmit the message to all I-CSCF nodes increases. A longer transmission time can lead to a delay between the time that the status of the S-CSCF node changed (e.g., an increase in congestion at the S-CSCF node) and the time that the furthest I-CSCF node from the I-CSCF node that originated the status message receives the message. A significant delay can lead to faulty decision making by the furthest I-CSCF node. For example, the furthest I-CSCF node can continue to allocate sessions to an S-CSCF node that had reported an overload condition because the furthest I-CSCF node is not aware of the overload until the furthest I-CSCF node receives the status update.

As shown in FIG. 5, the longest path between two I-CSCF nodes is four hops (e.g., node 502 to node 504, node 504 to node 508, node 508 to node 512, and node 512 to node 516) because the connections between the I-CSCF nodes 502-516 are unidirectional. As a result, status update messages traverse at least half of the I-CSCF nodes 502-516 before the messages are likely to have reached every I-CSCF node 502-516. It should be understood that a longest path of four hops is only one embodiment; for other configurations of I-CSCF nodes, the longest path can be greater or less than four hops.

B) Isolation

The failure of connections between I-CSCF nodes can result in isolation of an I-CSCF node from its peers due to the unidirectional configuration of the connections. Using FIG. 5 as an example, node 504 is connected to two downstream nodes (nodes 506 and 508) and receives status information from two other nodes (nodes 502 and 516). In the event that the inbound connections to node 504 from nodes 502 and 516 experience failure, node 504 can be unable to receive any more status information update messages because the only remaining connections at node 504 are outbound connections. Node 504 may have outdated S-CSCF status information, resulting in faulty service decision making by node 504.

C) Enhancements to Resolve the Longest Path and Isolation Complexities

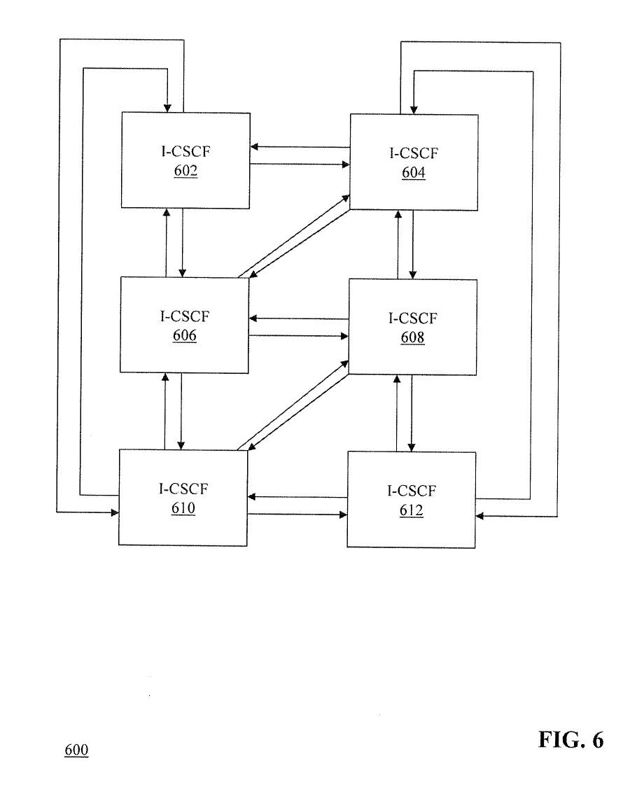

In some embodiments, the longest path and isolation complexities are resolved by modifying the directionality of the connections between the I-CSCF nodes. FIG. 6 is a block diagram of an exemplary I-CSCF node configuration 600 for sharing the status of S-CSCF nodes across a plurality of I-CSCF nodes 602-612 in a communications network, where the connections between the I-CSCF nodes 602-612 are bidirectional.

As shown in FIG. 6, each of the I-CSCF nodes 602-612 is connected to a plurality of other I-CSCF nodes via bidirectional connections. For example, node 602 is connected to nodes 604, 606, and 610. Node 602 sends and receives S-CSCF status messages to each of the nodes 604, 606, and 610 using the bidirectional connections. Although FIG. 6 shows the connections as two separate paths, one incoming and one outgoing, it should be understood that the connections are not limited to two separate physical connections between I-CSCF nodes and can also comprise a single physical and/or logical connection with the capability of receiving and transmitting data.

The bidirectional I-CSCF node configuration 600 shown in FIG. 6 provides an advantage of improving the efficiency related to the longest path complexity. Instead of requiring four hops for a status message to reach every I-CSCF node (as described above in relation to FIG. 5), the bidirectional I-CSCF node configuration 600 requires only two hops for a status message to be received by each I-CSCF node. As an example, a status message originated by node 602 takes a maximum of two hops to arrive at the farthest nodes 608 (e.g., node 602 to node 604, node 604 to node 608) or 612 (e.g., node 602 to node 604, node 604 to node 612). Therefore, the configuration 600 reduces the amount of time required for a status message to reach all I-CSCF nodes, improving the awareness of the I-CSCF nodes regarding changes in S-CSCF status and resulting in more accurate decision making by the I-CSCF nodes.

In addition, the bidirectional I-CSCF node configuration 600 eliminates the complexity of I-CSCF nodes becoming isolated due to connection or equipment failure. Because each I-CSCF node 602-612 is connected to a plurality of other nodes in a bidirectional configuration, each node 602-612 receives all status updates from the other nodes—even if the receiving node only has one connection available.

As described above, each I-CSCF node (e.g., node 602) in the configuration 600 transmits status updates to all of the I-CSCF nodes to which the node 602 is connected, resulting in the creation and transmission of an increased number of duplicate status messages. The increased number of duplicates results in additional processing and communication load on the network.

In some embodiments, the techniques and configuration 600 of FIG. 6 are further enhanced by providing additional logic at each I-CSCF node 602-612 to direct status messages received from other nodes using a directionally-aware technique. For example, still referring to FIG. 6, I-CSCF node 604 receives a status update message from another I-CSCF node (e.g., node 602). Node 604 recognizes that the status update message was sent from node 602, configured as an upstream node to node 604. Because node 604 is aware that the message arrived from upstream node 602, node 604 only transmits the received status message to downstream nodes 606 and 608, instead of transmitting the message using all of the available connections (e.g., to nodes 602, 606, 608 and 612). Similarly, upon receiving a status update message from node 606, node 604 transmits the status message to nodes 602 and 612, instead of transmitting the message to nodes 602, 606, 608 and 612. In addition, node 604 transmits messages originated at node 604 to each of its peer nodes 602, 606, 608 and 612.

In some embodiments, the I-CSCF nodes 602-612 can determine whether their peer nodes are upstream or downstream using a variety of methods. For example, the I-CSCF nodes 602-612 can be preconfigured by storing a network structure at each of the nodes 602-612. At start-up time, the nodes 602-612 initialize the connections to each other with an understanding of which peer nodes are upstream and downstream. In another example, an I-CSCF node can broadcast the network structure to each of the other nodes 602-612 at start-up time.

In yet another example, each of the nodes 602-612 is configured with the IP addresses for a plurality of downstream nodes (e.g., node 604 is configured with the IP addresses of nodes 606 and 608). At start-up time, the nodes 602-612 each establish connections to their respective configured downstream nodes. In addition, the nodes 602-612 receive connection requests from a plurality of additional nodes considered to be ‘upstream’ from the receiving node (e.g., node 604 receives connection requests from nodes 602 and 612). The effect of a node receiving connection requests from upstream nodes is that the receiving node has learned of the existence of the upstream nodes and associated connections, and can leverage the upstream connections in execution of the techniques described herein.

For example, if node 604 receives S-CSCF status information from upstream nodes 602 and 612, node 604 passes the status information on to its downstream nodes 606 and 608. Conversely, if node 604 receives S-CSCF status information from downstream nodes 606 and 608, node 604 passes the status information on to its upstream nodes 602 and 612. There can be exceptions to this directionally-aware technique, including the following:
1) The first node to receive status update information from an S-CSCF node broadcasts the status update information to all of its peer nodes in all directions. For example, if node 604 receives status update information from an S-CSCF node to which node 604 is directly connected, node 604 transmits the status update to each of nodes 602, 606, 608, and 612. The nodes adjacent to the originating node then commit to a particular direction and forward the status update information in that chosen direction. Continuing with the example, when node 606 receives the status update information from node 604, node 606 transmits the status update only to nodes 608 and 610. The directional commitment of the adjacent nodes only lasts for the duration of the status update message. The next status update message restarts the logic for determining the directionality of status update transmission.
2) If a node is isolated, the node can ask its remaining neighbor to ignore direction and send status update information back to the isolate node. For example, if node 608 only has a connection to node 610, node 608 sends a request asking node 610 to ignore the limitation that node 610 is downstream from node 608 and instead send status updates to node 608. Therefore, the node receiving the request (e.g., node 610) sends status update information towards the isolated node (e.g., node 608), irrespective of which direction the status update information was received in.

The directionally-aware technique described above provides an advantage of improving the efficiency of status message transmission because as the status messages are originated and transmitted in one direction by the originating I-CSCF node, the messages continue to travel in that direction without generating duplicates sent back to upstream I-CSCF nodes. The directionally-aware technique, however, reintroduces the isolation complexity as an I-CSCF node can be connected to other I-CSCF nodes in only one direction. Depending on which I-CSCF node originates the status update message, an I-CSCF node with reduced connectivity to its peers may not be connected in the correct direction that the message is communicated in from the originating I-CSCF node and may not receive the message.

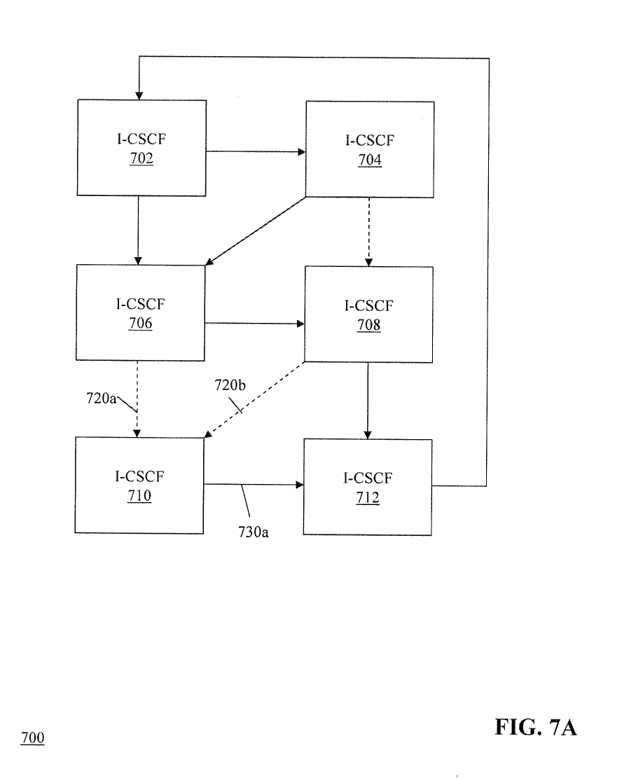

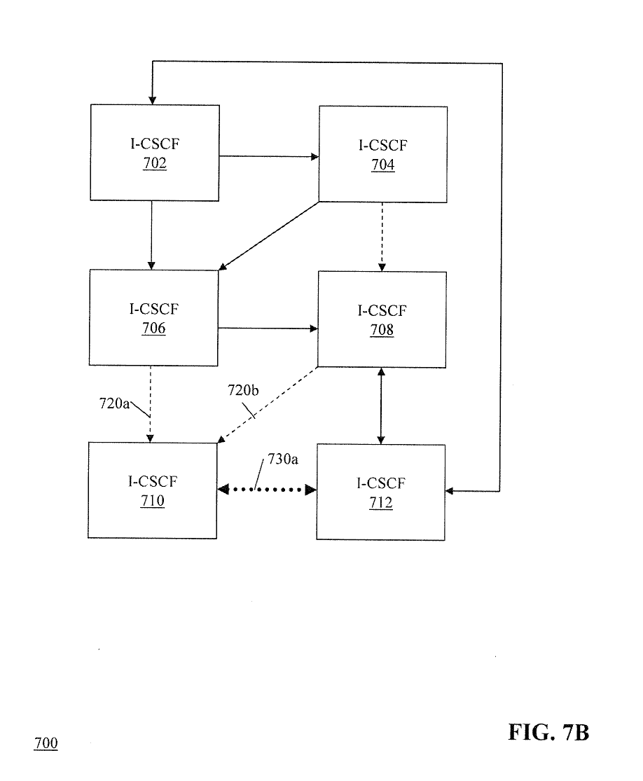

In some embodiments, the bidirectional node configuration 600 of FIG. 6 and the directionally-aware technique are further enhanced by modifying the connections between I-CSCF nodes to have adaptive directionality. Using the adaptive directionality technique, I-CSCF nodes are connected to other I-CSCF nodes via unidirectional connections and the I-CSCF nodes include logic to switch the directionality of the connections based on network conditions (e.g., connectivity failure). FIGS. 7A-7B are block diagrams of an exemplary I-CSCF node configuration 700 for sharing the status of S-CSCF nodes across a plurality of I-CSCF nodes 702-712 in a communications network, where the connections between the I-CSCF nodes 702-712 are adaptive.

As shown in FIG. 7A, each of the I-CSCF nodes 702-712 is connected to other I-CSCF nodes via unidirectional connections. The I-CSCF nodes 702-712 include additional logic to monitor the connection status with their peer nodes. For example, I-CSCF node 710 monitors the availability of connection 720a with node 706, connection 720b with node 708 and connection 730a with node 712. The dashed lines of connections 720a and 720b indicate that those connections have failed. As a result, I-CSCF node 710 is isolated from the other I-CSCF nodes and does not receive any status updates because node 710 has lost connectivity to its upstream peers 706 and 708. I-CSCF node 710 recognizes that the inbound connections has not available and transmits a notification message via the remaining connection 730a to node 712, indicating that node 710 has lost upstream connectivity.

When I-CSCF node 712 receives the notification message from node 710, node 712 converts the unidirectional connection between nodes 710 and 712 into a bidirectional connection 730a. The bidirectional connection 730a is shown as dotted lines in FIG. 7B. Node 710 receives status update messages from node 712, and the status update messages include update message received by node 712 from other I-CSCF nodes in the network. As a result, node 710 continues to receive a complete view of the S-CSCF status across the entire network even though its connectivity is limited to a single node 712.

An advantage of the adaptive directionality technique is efficiency in the number of status messages transmitted between the I-CSCF nodes 702-712. Only one connection 730a to node 712 is switched from unidirectional to bidirectional, leaving connections between node 712 and other I-CSCF nodes (e.g., nodes 702, 708) as unidirectional and resulting in fewer status message transmissions than if all of the connections between node 712 and other I-CSCF nodes in the network switched to bidirectional. Another advantage of the adaptive directionality technique is the elimination of the complexity of I-CSCF nodes becoming isolated due to connection or equipment failure. Because any I-CSCF node (e.g., node 710) that loses connectivity to I-CSCF nodes in a single direction (e.g., upstream or downstream) retain a viable connection to at least one other I-CSCF node, each node 702-712 receives all status updates from the other nodes—even if the receiving node only has one connection available.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, and/or other communication protocols.

Devices of the computing system can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). Mobile computing device include, for example, a Blackberry®. IP phones include, for example, a Cisco® Unified IP Phone 7985G available from Cisco Systems, Inc, and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A method for sharing the status of S-CSCF nodes across a plurality of I-CSCF nodes in a communications network, the method comprising:
monitoring, at a first I-CSCF node of the plurality of I-CSCF nodes, the status of one or more S-CSCF nodes connected to the first I-CSCF node, wherein the one or more S-CSCF nodes connected to the first I-CSCF node comprise a first subset of the S-CSCF nodes in the network;
monitoring, at a second I-CSCF node of the plurality of I-CSCF nodes, the status of one or more S-CSCF nodes connected to the second I-CSCF node, wherein the one or more S-CSCF nodes connected to the second I-CSCF node comprise a second subset of the S-CSCF nodes in the network; and
transmitting, from the first I-CSCF node to the second I-CSCF node, the monitored status of the one or more S-CSCF nodes connected to the first I-CSCF node.

2. The method of claim 1, wherein at least one S-CSCF node in the first subset of the S-CSCF nodes is also in the second subset of S-CSCF nodes in the network.

3. The method of claim 1, further comprising:
transmitting, from the first I-CSCF node to a third I-CSCF node of the plurality of I-CSCF nodes, the monitored status of the one or more S-CSCF nodes connected to the first I-CSCF node.

4. The method of claim 1, further comprising:
transmitting, from the second I-CSCF node to a third I-CSCF node of the plurality of I-CSCF nodes, the monitored status of the one or more S-CSCF nodes connected to the first I-CSCF node.

5. The method of claim 1, wherein at least one of the one or more S-CSCF nodes connected to the second I-CSCF node is also monitored by the first I-CSCF node.

6. The method of claim 1, wherein the monitored status of each of the one or more S-CSCF nodes connected to the first I-CSCF node includes an identification attribute associated with a time, a duration, or both of an event occurring at the one or more S-CSCF nodes.

7. The method of claim 6, wherein the identification attribute comprises at least one of a timestamp, a hash value, and an identification number.

8. The method of claim 1, wherein monitoring the status of one or more S-CSCF nodes connected to the first I-CSCF node includes active probing of the one or more S-CSCF nodes by the first I-CSCF node.

9. The method of claim 1, wherein monitoring the status of one or more S-CSCF nodes connected to the first I-CSCF node includes passive analysis of traffic received from the one or more S-CSCF nodes by the first I-CSCF node.

10. The method of claim 1, further comprising:
receiving, at the first I-CSCF node from the second I-CSCF node, the monitored status of one or more S-CSCF nodes connected to the second I-CSCF node; and
storing, at the first I-CSCF node, the monitored status of the one or more S-CSCF nodes connected to the second I-CSCF node.

11. The method of claim 10, wherein the first I-CSCF node stores the monitored status of the one or more S-CSCF nodes connected to the second I-CSCF node in a data structure located at the first I-CSCF node.

12. The method of claim 10, further comprising:
receiving, at the first I-CSCF node from a third I-CSCF node of the plurality of I-CSCF nodes, the monitored status of one or more S-CSCF nodes connected to the third I-CSCF node; and
storing, at the first I-CSCF node, the monitored status of the one or more S-CSCF nodes connected to the third I-CSCF node.

13. The method of claim 12, further comprising:
receiving, at the first I-CSCF node, a service request from a remote device;
routing, by the first I-CSCF node, the service request to one of the S-CSCF nodes in the network, wherein the routing is based on the monitored status of the S-CSCF nodes.

14. The method of claim 12, further comprising:
transmitting, from the first I-CSCF node to the second I-CSCF node, the monitored status of the one or more S-CSCF nodes connected to the third I-CSCF node.

15. The method of claim 12, further comprising:
receiving, at the first I-CSCF node from the second I-CSCF node, an update to the monitored status of the one or more S-CSCF nodes connected to the second I-CSCF node; and
storing, at the first I-CSCF node, the update to the monitored status of the one or more S-CSCF nodes connected to the second I-CSCF node.

16. The method of claim 15, further comprising:
receiving, at the first I-CSCF node from the third I-CSCF node, an update to the monitored status of the one or more S-CSCF nodes connected to the second I-CSCF node;
comparing, at the first I-CSCF node, an identification attribute of the update received from the third I-CSCF node with an identification attribute of the update received from the second I-CSCF node; and
discarding, at the first I-CSCF node, the update received from the third I-CSCF node if the identification attribute of the update received from the third I-CSCF node and the identification attribute of the update received from the second I-CSCF node match.

17. The method of claim 15 wherein the second I-CSCF node transmits the update based on a change in the monitored status of the one or more S-CSCF nodes connected to the second I-CSCF node.

18. The method of claim 1, further comprising:
monitoring, at the first I-CSCF node, the connection between the first I-CSCF node and the second I-CSCF node.

19. The method of claim 18, wherein the connection between the first I-CSCF node and the second I-CSCF node is unidirectional from the first I-CSCF node and the second I-CSCF node.

20. The method of claim 19, further comprising:
detecting, at the first I-CSCF node, a failure of the connection between the first I-CSCF node and the second I-CSCF node; and
transmitting, from the first I-CSCF node to a third I-CSCF node, an indication of the failure of the connection between the first I-CSCF node and the second I-CSCF node, wherein the connection between the first I-CSCF node and the third I-CSCF node is unidirectional from the first I-CSCF node to the third I-CSCF node.

21. The method of claim 20, further comprising:
updating, at the third I-CSCF node, the connection between the first I-CSCF node and the third I-CSCF node to be bidirectional; and
transmitting, from the third I-CSCF node to the first I-CSCF node, the monitored status of one or more S-CSCF nodes connected to the third I-CSCF node.

22. The method of claim 1, wherein the directionality of the connection between the first I-CSCF node and the second I-CSCF node is preconfigured at the first I-CSCF node.

23. The method of claim 1, wherein the connection between the first I-CSCF node and the second I-CSCF node is defined by an IP address of the second I-SCSF node stored at the first I-CSCF node.

24. The method of claim 1, wherein the connection between the first I-CSCF node and the second I-CSCF node is defined by an IP address of the first I-SCSF node discovered by the second I-CSCF node upon receiving a connection request from the first I-CSCF node.

25. The method of claim 24, wherein the discovery of the IP address of the first I-CSCF node by the second I-CSCF node is based on a packet received from the first I-CSCF node.

26. The method of claim 25, wherein the IP address of the first I-CSCF node is stored in a source address field of the packet received from the first I-CSCF node.

27. The method of claim 25, wherein the packet received from the first I-CSCF node is the first packet in a handshake routine associated with the connection request.

28. The method of claim 1, wherein the connection between the first I-CSCF node and each one of the one or more S-CSCF nodes connected to the first I-CSCF node is defined by an IP address of each one of the one or more S-CSCF nodes stored at the first I-CSCF node.

29. The method of claim 1, wherein the connection between the first I-CSCF node and each one of the one or more S-CSCF nodes connected to the first I-CSCF node is defined by an IP address of each one of the one or more S-CSCF nodes discovered by the first I-CSCF node upon starting up the first I-CSCF node.

30. The method of claim 1, wherein the plurality of I-CSCF nodes in the communications network are arranged in a flat chain structure, a ring structure, a hierarchical structure, a full mesh structure, or one or more partial mesh structures.

31. The method of claim 1, wherein the monitored status of the one or more S-CSCF nodes connected to the first I-CSCF node includes at least one of workload data, availability data, traffic congestion data, and control data.

32. A system for sharing the status of S-CSCF nodes across a plurality of I-CSCF nodes in a communications network, the system comprising:
a first I-CSCF node of the plurality of I-CSCF nodes configured to:
monitor status of one or more S-CSCF nodes connected to the first I-CSCF node, wherein the one or more S-CSCF nodes connected to the first I-CSCF node comprise a subset of the S-CSCF nodes in the network; and
transmit the monitored status of the one or more S-CSCF nodes connected to the first I-CSCF node to a second I-CSCF node of the plurality of I-CSCF nodes; and
the second I-SCSF node configured to monitor status of one or more S-CSCF nodes connected to the second I-CSCF node, wherein the one or more S-CSCF nodes connected to the second I-CSCF node comprise a subset of the S-CSCF nodes in the network.

33. A computer program product, tangibly embodied on a computer readable storage medium, for sharing the status of S-CSCF nodes across a plurality of I-CSCF nodes in a communications network, the computer program product including instructions operable to cause a data processing apparatus to:
monitor, at a first I-CSCF node of the plurality of I-CSCF nodes, the status of one or more S-CSCF nodes connected to the first I-CSCF node, wherein the one or more S-CSCF nodes connected to the first I-CSCF node comprise a subset of the S-CSCF nodes in the network;
monitor, at a second I-CSCF node of the plurality of I-CSCF nodes, the status of one or more S-CSCF nodes connected to the second I-CSCF node, wherein the one or more S-CSCF nodes connected to the second I-CSCF node comprise a subset of the S-CSCF nodes in the network; and
transmit, from the first I-CSCF node to the second I-CSCF node, the monitored status of the one or more S-CSCF nodes connected to the first I-CSCF node.
